(19) United States
(12) Patent Application Publication
(10) Pub. No.: US 2017/0345329 A1
(43) Pub. Date: Nov. 30, 2017

(54) Integrated System and Method for Providing Users With Non-destructive Ways of Manipulating Musical Scores and/or Audio Recordings for Student Practise, Testing and Assessment

(71) Applicant: Rising Software Australia Pty Ltd., Fairfield (AU)

(72) Inventors: Peter Tien Lan LEE, Fairfield (AU); Timothy Mark WILSON, Nunawading (AU); Hamish Neil MOFFATT, Kew (AU); Anthony (Tony) RIETWYK, Richmond (AU); William THORPE, Auckland (NZ)

(73) Assignee: Rising Software Australia Pty Ltd., Fairfield (AU)

(21) Appl. No.: 15/669,954

(22) Filed: Aug. 6, 2017

Related U.S. Application Data
(63) Continuation of application No. 15/178,634, filed on Jun. 10, 2016, now abandoned.

(30) Foreign Application Priority Data
Jun. 12, 2015 (AU) 2015902237

(51) Int. Cl. G09B 15/00; G09B 7/06; G10G 1/00

(52) U.S. Cl. CPC G09B 15/00; G10G 1/00; G09B 7/06; G10H 2210/375; G10H 2220/015; G10H 2210/056

(57) ABSTRACT

An integrated system and method that provides users with non-destructive ways of manipulating musical scores and or audio recordings for student practise, testing and assessment. The said integrated system and method allows users to create questions that utilise one or more of the manipulated items, present questions to a student, collect the said students answer and assess the said students answer. The said integrated system is delivered via digital devices including computers, tablets, smartphones and other such devices.

### CROSS-REFERENCE TO RELATED APPLICATIONS

This application is a Continuation of U.S. patent application Ser. No. 15/178,634, filed on Jun. 10, 2016, which in turn is based upon and claims priority under 35 U.S.C. 119(e) to Australian Provisional Patent Application Number 2015902237 entitled “An integrated system providing users with non-destructive ways of manipulating musical notation and or audio recordings for student practise, testing and assessment.” Both of the aforementioned patent applications are herein incorporated by reference in their entirety for all purposes.

### BACKGROUND

The use of electronic systems to assist with the teaching and learning of music and providing feedback to students is important and well known. Many patents such as US 2011/0283866 (‘866’), US 2014/0260903 (‘903’) and WO 2010/083563 (‘563’) have claimed systems with respect to teaching the playing of music and providing feedback.

The claimed invention is not concerned with the playing of music and important points which distinguish the claimed invention from ‘866’, ‘903’ and ‘563’ are that no instrument is required and that it is not a prescriptive learning method.

There are also many systems available that are concerned with electronic learning platforms. Patents such as US 2013/0052631 (‘631’), US 2013/0266924 (‘924’) and US 2007/0196807 (‘807’) cover general courseware, that may or may not have music as an intended subject area. They certainly do not concern themselves with musical scores, non-destructive editing of musical scores and non-destructive editing of audio recordings.

Other patents such as US 2013/0164727 (‘727’) are more musical in their approach, and indeed mention musical scores and their display, in the context of student answering questions. Again, there is no mention of non-destructive editing of musical scores.

The patent WO 95/25312 (‘312’) is concerned with creating new works from recordings, using sub selections from the recordings without altering the original. ‘312’ has two separate software applications, one for creating marker points and one for playing the resulting composition back. ‘312’ does not concern itself with; integrated systems, non-destructive editing of musical scores and questions, answers, assessment and feedback.

The patent US 2012/0259788 (‘788’) is not dissimilar to ‘312’ and again does not concern itself with; integrated systems, non-destructive editing of musical scores and questions, answers, assessment and feedback.

With electronic learning systems being present in most educational institutions, there are ongoing debates about their value and benefit.

The primary benefit when using such systems concerns the student. In well-designed systems students have the ability to practise as many questions as they desire, while receiving quality feedback. Their results will all be recorded for later instructor review.

The other benefit, arguably more important, concerns the instructor. The use of such a system gives them the ability to track students with minimal effort, set tasks and activities, monitor progress and easily provide differentiated learning opportunities.

Using such a system imposes some workload on the instructor, which should be easily offset by the reduction in traditional grading and monitoring tasks.

Many instructors find it useful to include their own content into such systems if possible, which can ensure that content is closely matched to the curriculum requirements of their student body.

In the area of teaching music, inclusion of content can be very time consuming, involving media selection, media manipulation and management and ultimately the creation of questions to present to their students.

As an example, an instructor may have an audio recording of a string quartet that is ten minutes long. They would like to use this work in their teaching as part of a melodic dictation question. Such a recording is generally too long for an instructor to use in most single questions. Instead, they would want to use smaller sections from that recording, and quite possibly multiple sections from the same recording.

Traditionally the instructor would have to edit the recording and produce multiple audio files that need management and filing before using them with student questions.

A very common question is to ask the student to transcribe some music after listening to the audio recording. In this case the question could be ‘Transcribe the Violin I’ part.

The instructor would need to devise a method whereby the student could enter their answer, in this case the transcription of the Violin I part in the audio recording that the instructor has manipulated.

In years past the instructor may start with a blank sheet of manuscript, add relevant items such as meter and key signatures, and possibly a starting note. This sheet would then be photocopied and distributed to the students.

A more modern method would involve the instructor starting with the musical score that matches the audio recording. The instructor would open the musical score in a suitable editing package, remove the Violin II, Viola and Cello parts and edit the Violin I part. The editing of the Violin I part would involve remove all notes except the first note of the example, which is a very common way to present the student with such a question. The file would then need to be saved and hard copies created for distribution to students for answer submission.

It is important to note that in the method just described, the saved musical score containing the remnants of the Violin I part has no connection to the original musical score, they are completely separate.

The management of these musical scores is laborious, time consuming and error prone.

Also, both of these traditional methods require the instructor to assess each student response individually and the said ‘modern method’ involves destructive editing of the musical score, which create long term administration and musical score management tasks.

In the claimed invention, a fast and integrated method to non-destructively edit audio recordings and musical scores with a question and assessment system is described, saving instructors countless hours.

### SUMMARY OF INVENTION

An integrated system and method that provides instructors with non-destructive ways of manipulating musical scores and or audio recordings for student practise, testing and assessment. The said integrated system and method allows instructors to create questions that utilise one or more of the manipulated items, present questions to a student, collect the said students answer and assess the said students answer. The said integrated system is delivered via digital devices including computers, tablets, smartphones and other such devices.

The said non-destructive editing allows instructors to optionally create extracts of musical scores or audio recordings. Audio extracts have starting and ending timestamps, allowing instructors to specify smaller timespans to be played.

Musical score extracts have starting and finishing measures and beats, allowing instructors to specify a smaller timespan from the entire work. These musical score extracts can be used for playback, display and student musical score interaction.

The said integrated system allows creation of notation, tapping and multiple-choice questions. Each of these questions allows the use of audio and or musical score extracts or the entire work. A single extract or entire work may be re-used in more than one question.

Further non-destructive editing of musical scores can be undertaken once a musical score extract or entire musical score is chosen for use in a question. This editing can include hiding of some musical parts, making parts editable or locked, muting parts, hiding individual notes and changing parts to a percussion staff. Many combinations of these choices are possible, for a single question, without altering the original musical score or altering any other question that has used the same extract or entire work with other non-destructive edits.

Depending on the question type, the non-destructive edits can affect playback, display, student musical score interaction or a combination of these, with separate non-destructive edits allowed for each area of use.

Instructors may use questions for student practise, within a test or within a course. In each case, questions are presented to a student, an answer is collected and assessed and students may receive feedback and or results.

### BRIEF DESCRIPTION OF FIGURES

FIG. 1 illustrates the library, showing a listing of media items organised by composer, with audio and musical scores. Some items have arrows on them indicating that the item has extracts.

FIG. 2 illustrates the extract editor with an audio file and starting and ending points selected.

FIG. 3 illustrates the extract editor with a musical score. A timespan of measures is selected.

FIG. 4 illustrates the musical score or notation editor, with an entire work displayed.

FIG. 5 illustrates the musical score or notation editor, with an extract from the work in FIG. 4. This particular extract is only the first four measures.

FIG. 6 illustrates the musical score or notation editor with another extract from the work in FIG. 4. The extract is the last four measures of the work.

FIG. 7 illustrates the question editor, with a notation question (melodic dictation). The playback is audio and the student will enter their answer on the selected musical score or notation.

FIG. 8 illustrates the question editor, with a notation question (rhythmic dictation). The playback is audio and the student will enter their answer on the selected musical score or notation.

FIG. 9 illustrates the question editor, with a tapping question. A musical score is selected for display to the student, who will tap the rhythm with a click track.

FIG. 10 illustrates the question editor, with a multiple-choice question, the answers being a selection of musical scores or notation. There is also playback, in this case a musical score or notation.

FIG. 11 illustrates the choices editor that is used when creating a multiple-choice question such as that in FIG. 10. In this case there are four musical score or notation choices, each of which may be an extract such as that in FIG. 3 or an entire piece such as FIG. 4.

FIG. 12 illustrates a musical score when editing non-destructively, while preparing a question as per FIG. 7 for student use. The Violin I part is visible and editable, with all notes hidden and measures ready for student entry except the first two note. The Violin II part is hidden, and the Viola and Cello parts are visible, but not editable. The Double Bass part is visible and editable, but with some measures hidden and ready for student entry.

FIG. 13 illustrates a musical score when editing non-destructively, while preparing a question as per FIG. 8 for student use. All parts are hidden except the Double Bass, where all measures are hidden and ready for student entry except the first full measure. The pitches of the notes have also been non-destructively removed, leaving only the rhythm, on a percussion staff.

FIG. 14 illustrates a musical score when editing non-destructively, while preparing a question as per FIG. 9 for student use, when the musical score is for display only. All parts are hidden except Violin I, which will be visible and has had pitches non-destructively removed, leaving only the rhythm, on a percussion staff.

FIG. 15 illustrates a musical score when editing non-destructively, while preparing a question as per FIG. 10 for student use, when the musical score is for display only. All parts are hidden except Violin I.

FIG. 16 illustrates a musical score when editing non-destructively, while preparing a question as per FIG. 10 for student use, when the musical score is for display only. All parts are hidden except Violin II.

FIG. 17 illustrates a musical score when editing non-destructively, while preparing a question for student use, when the musical score is for playback only. All parts are mute except Violin II, which will be heard by the student.

FIG. 18 illustrates a notation question when it is presented to the student. The musical score or notation that the student interacts with here was non-destructively edited in FIG. 12 as part of the question editing in FIG. 7.

FIG. 19 illustrates a notation question when it is presented to the student. The musical score or notation that the student interacts with was non-destructively edited in FIG. 13 as part of the question editing in FIG. 8.

FIG. 20 illustrates a tapping question when it is presented to the student. The musical score or notation that the student can see was non-destructively edited in FIG. 14 as part of the question editing in FIG. 9.

FIG. 21 illustrates a multiple-choice question with musical scores as answers when it is presented to the student. The musical scores or notation that the student can see were chosen in FIG. 11 and the musical score or notation playback that the students would hear was non-destructively edited in FIG. 17, as part of the question editing in FIG. 10.

FIG. 22 illustrates assessment and feedback that is presented to the student, after the question in FIG. 18.

FIG. 23 illustrates assessment and feedback that is presented to the student, after the question in FIG. 19.

FIG. 24 illustrates assessment and feedback that is presented to the student, after the question in FIG. 20.

FIG. 25 illustrates assessment and feedback that is presented to the student, after the question in FIG. 21.

FIG. 26 illustrates the library in a similar manner to FIG. 1, but with the extract listing for various items being expanded.

### DETAILED DESCRIPTION OF THE INVENTION

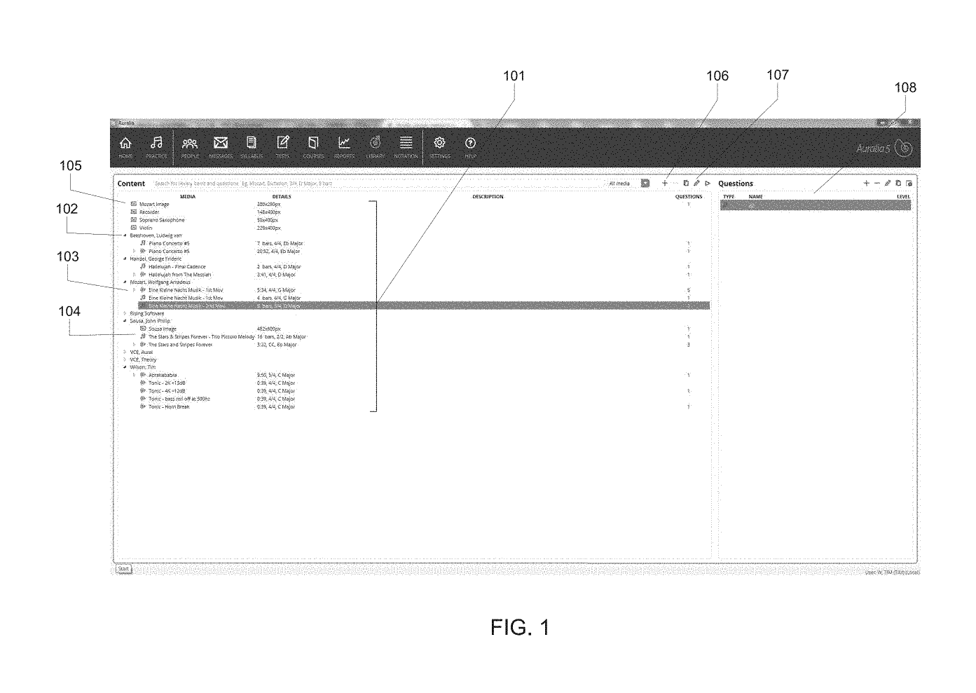

Each of FIGS. 1 to 26 show different embodiments of the invention being delivered using digital devices. The code is located on those digital devices. Digital devices include computers, tablets, smartphones and other such devices. A person skilled in the art may put the code on any of those devices or use any coding language as they see fit. It is not significant where any piece of code is located nor the language in which the code is written.

Referring to the drawings, FIG. 1 shows the library. This has a listing of media items 101, grouped by composer 102. Media items may include audio 103, musical score or notation 104, MIDI or images 105. Other media types may be used.

Media items are supplied by the publisher and third parties, but can also be added to the library by the instructor 106.

Audio and musical scores may have extracts, allowing instructors to use smaller parts of the item when creating questions.

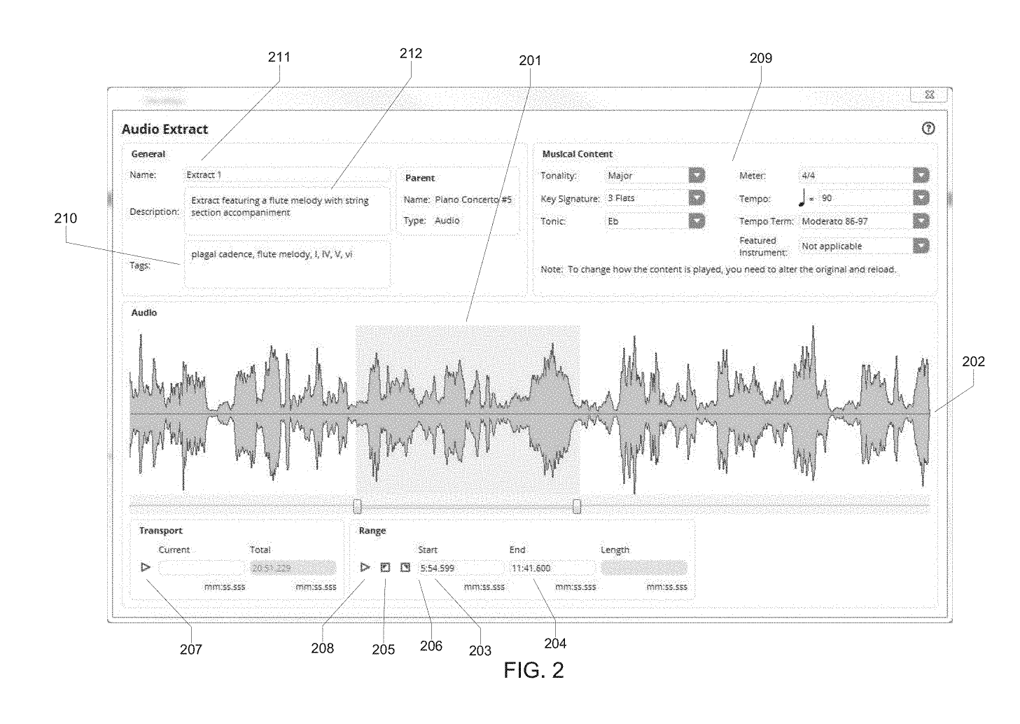

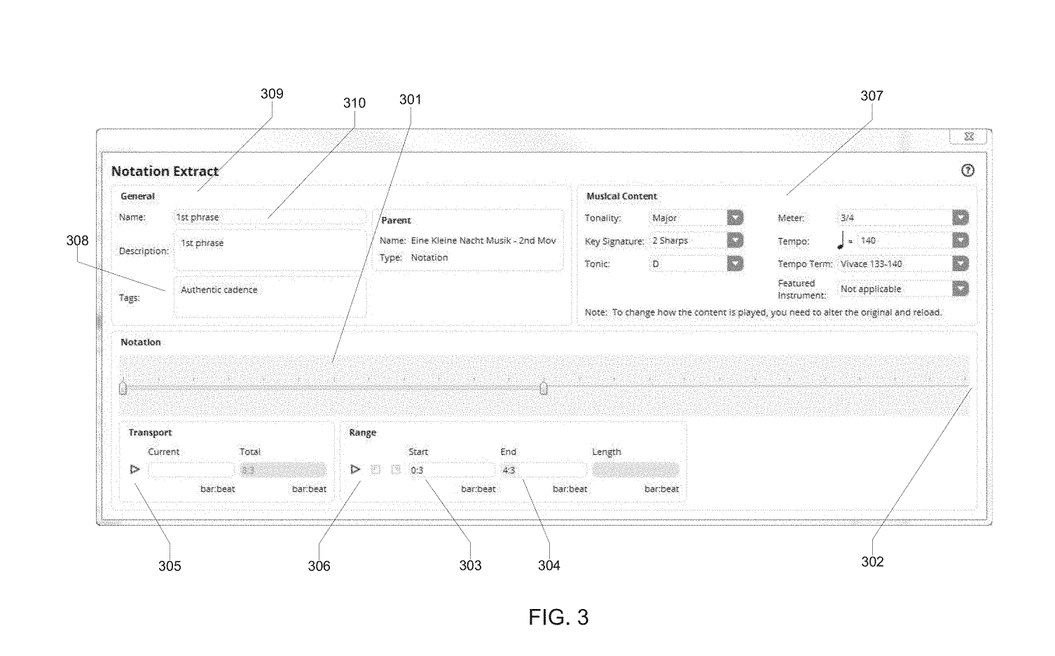

If extracts are present for an audio or musical score item, then this is indicated 103. New extracts may be created for any audio or musical score 106, once this action is chosen the instructor is taken to the extract editor in FIG. 2 and FIG. 3.

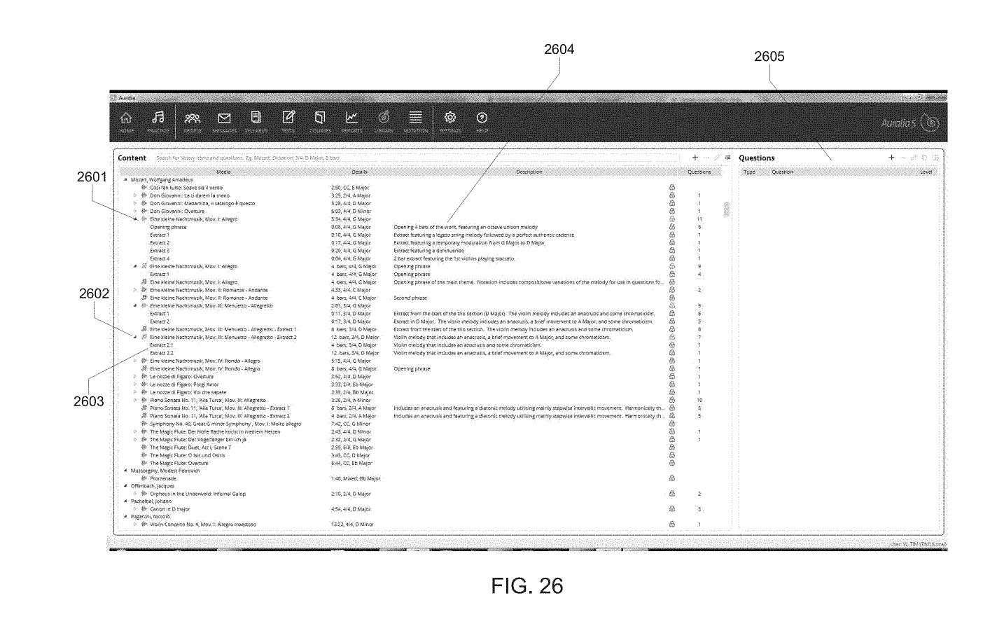

FIG. 26 shows the library with an audio item 2601 and musical score 2602 extract listing expanded, showing the names of the extracts and various details.

Referring now to FIG. 2, this shows an audio extract being edited, clearly showing 201 how an extract creates a slice of an entire work 202, editing the work in a non-destructive manner. Audio extracts have a starting 203 and ending 204 time and the interface provides a method to set these start and end points 205, 206 and playback the entire work 207 or the extract itself 208.

Audio extracts also have their own set of attributes 209 and tags 210 to facilitate searching.

FIG. 3 shows a music score extract being edited, clearly showing 301 how an extract creates a slice of an entire work 302, editing the work in non-destructive manner. Extracts of a musical score have a starting measure (bar) and beat 303 and ending measure (bar) and beat 304. The interface provides methods to set these start and end points, and also playback of the entire work 305 or the extract itself 306.

Musical score extracts also have their own set of attributes 307 and tags 308 to facilitate searching.

Both audio and musical score extracts have names 211, 309 and descriptions 212, 310 that can be displayed in various areas including the library 2603, 2604 and question editor.

A single extract may also be re-used within a question and also re-used in more than one question.

Note that creating an extract is not mandatory, questions can be created using an entire audio item or musical score.

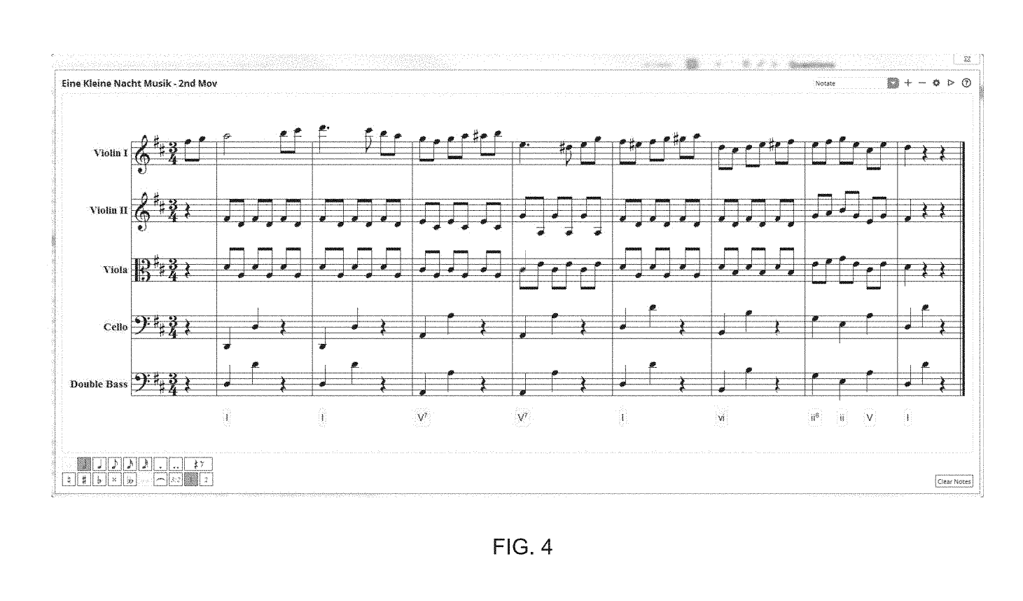

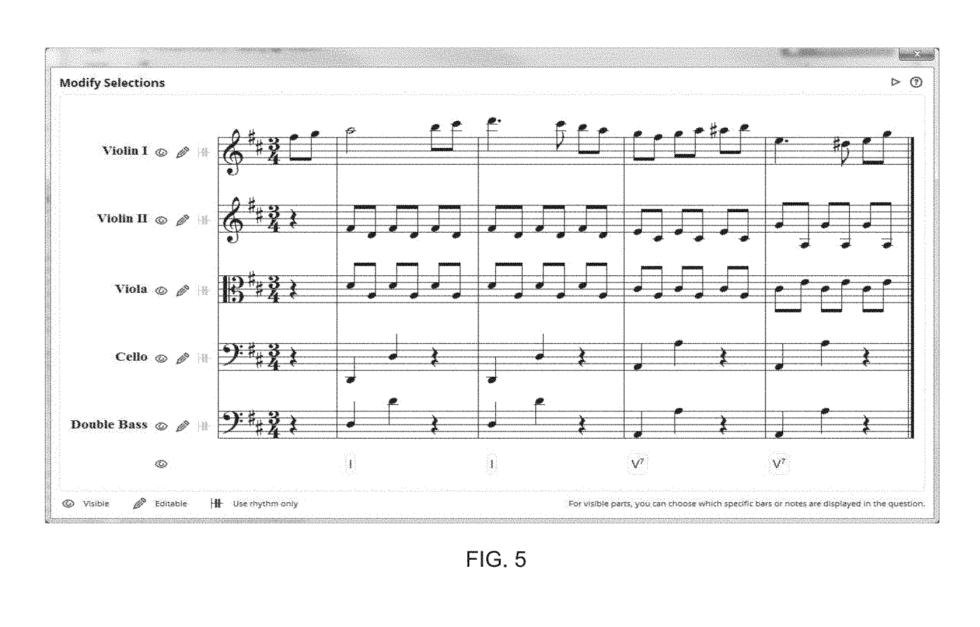

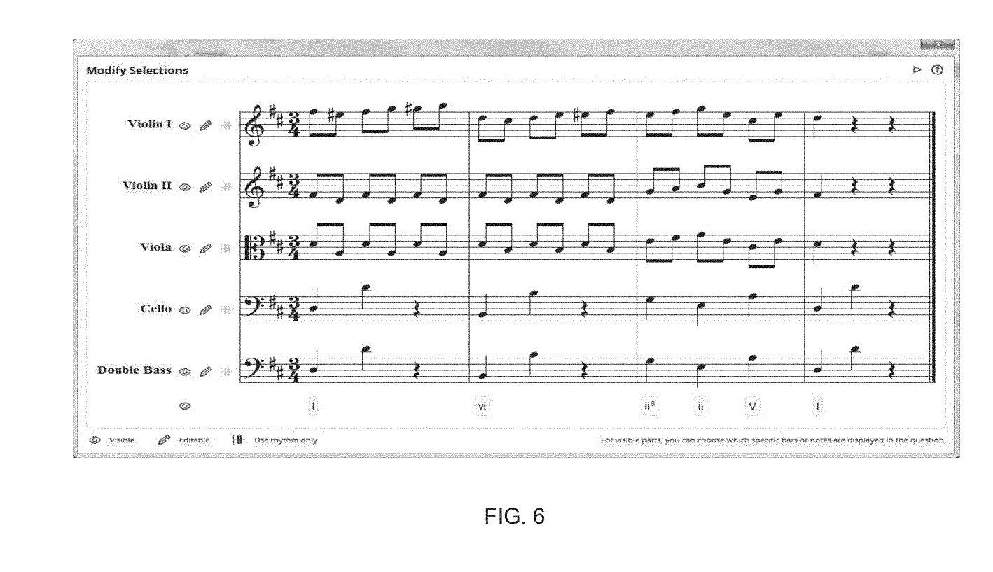

Referring now to FIG. 4 an entire musical score is shown in the integrated musical score or notation editor. FIG. 5 shows an extract of that score, measures 1 through 4. FIG. 6 shows another extract of that score, measures 5 through 8.

In both these figures, the extracts are being viewed after they have been chosen to be used as part of a question in the same way an entire piece has been chosen 707, they can also be viewed directly from the library 107.

Referring to FIG. 1 and FIG. 26, the library has an area listing questions that utilise the selected media item 108, 2605.

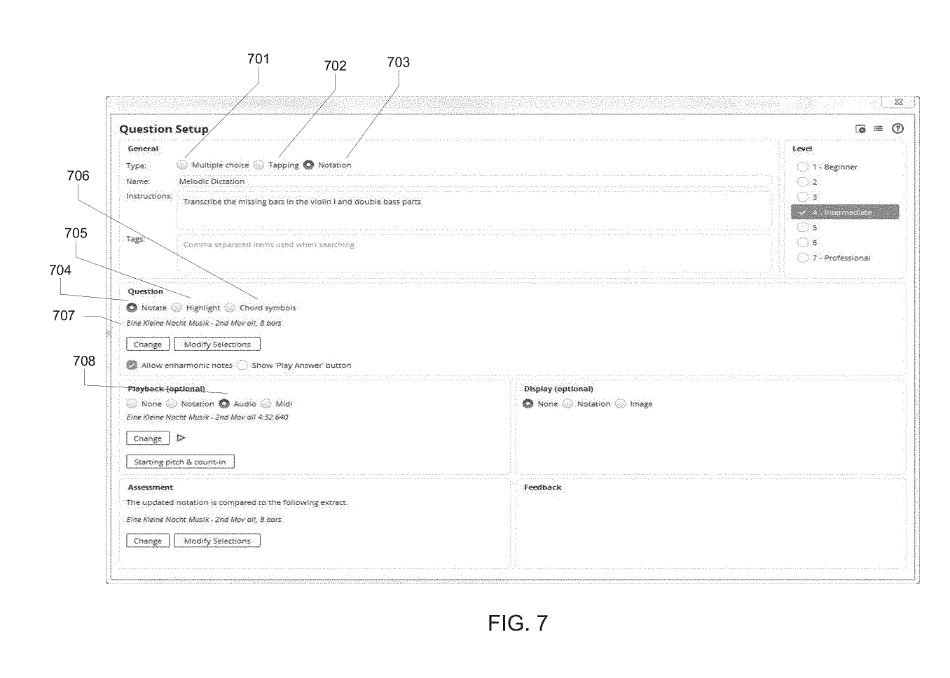

FIG. 7 shows the question editor, with the three types of questions, multiple choice 701, tapping 702 and notation 703; a notation question is selected in this instance.

A notation question allows the students to enter answers on a musical score 704, highlight elements on a musical score 705 or enter chord symbols on a musical score 706.

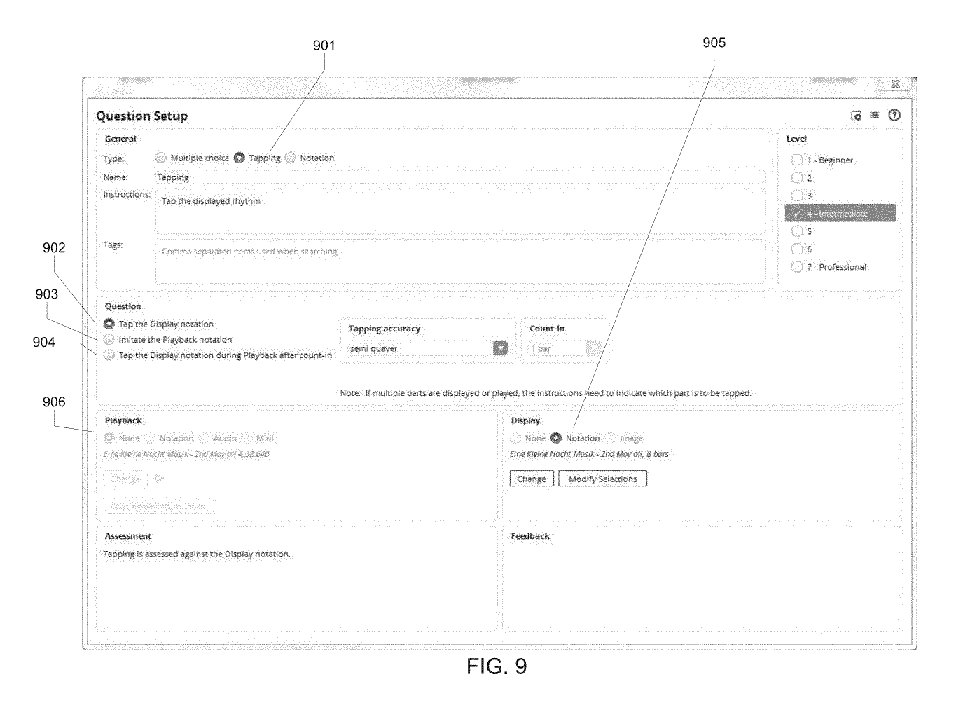

FIG. 9 shows the question editor with a tapping question selected 901.

Tapping questions allow the student to tap a musical score to a click track 902, remember and tap a played musical score 903 or tap along to a played musical score 904.

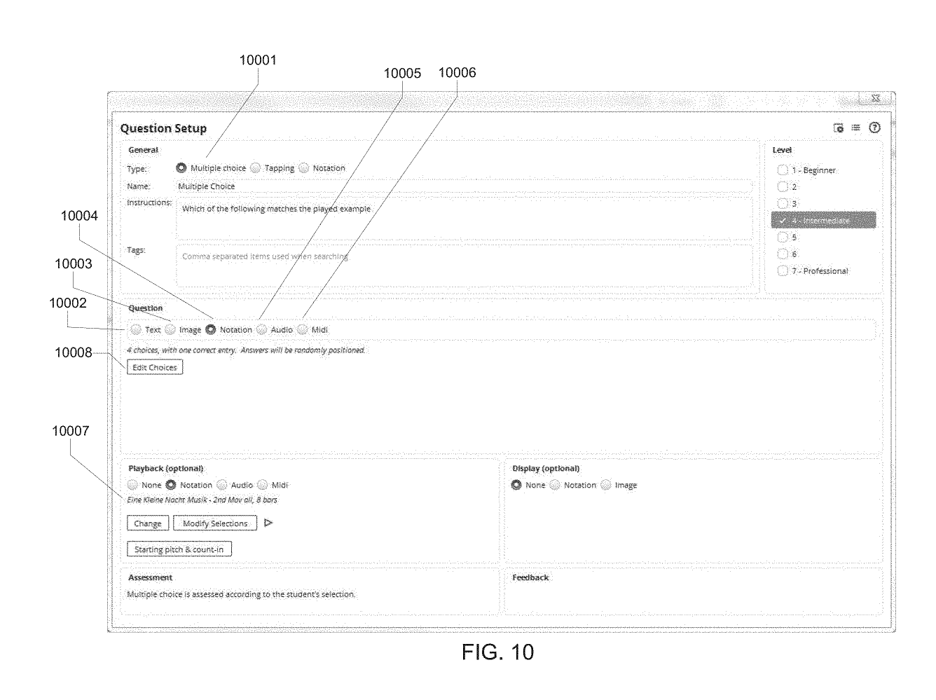

FIG. 10 shows the question editor with a multiple-choice question selected 10001.

A multiple-choice question allows answer types that are one of text 10002, images 10003, musical scores 10004, audio 10005 or midi files 100006.

In any of the question types, various selections of audio and musical scores may occur.

Audio items may be selected for playback 708, and the selection can be an entire work or it can be an extract as described earlier and shown on FIGS. 2 and 3.

Musical scores and musical score extracts can be chosen for the question itself (for student interaction) 707, for playback 10007, for display 905 or as multiple-choice answers 10004, 11001. Any of these selections may be an entire work or they may be an extract as described earlier and shown on FIGS. 2 and 3.

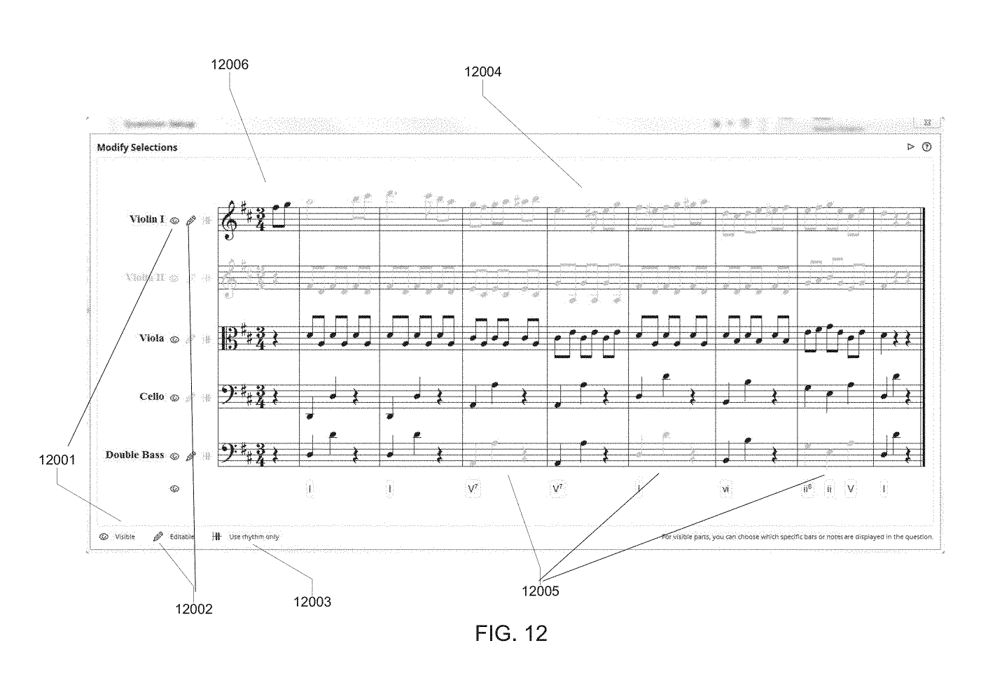

Referring now to FIGS. 12, 13, 14 and 15, when a musical score (entire work or extract) is chosen within a question, the instructor may non-destructively edit or manipulate the musical score.

These non-destructive edits or manipulations can involve one or more of these items, depending on type of question and answer type chosen for that question; selection of musical part(s) that are visible 12001, 13001; 15001 selection of musical parts that can be edited 12002, 13002; selection of measures or notes to be hidden 12004, 12005, 13003; toggling of musical part(s) to percussion staff and converting pitches to rhythmic values 14001.

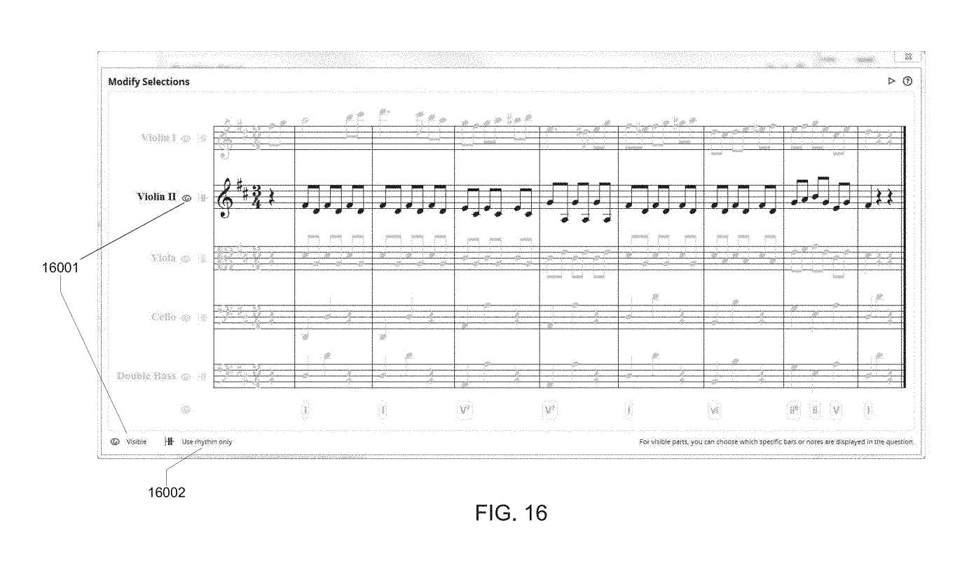

Referring now to FIG. 16, when a musical score (entire work or extract) is chosen within a question for display, the instructor may non-destructively edit or manipulate the musical score and select which musical part(s) will be displayed 16001. They may also toggle musical part(s) to percussion staff and convert the pitches to rhythmic values 16002; this is unused in FIG. 16, but 14001 shows this in use.

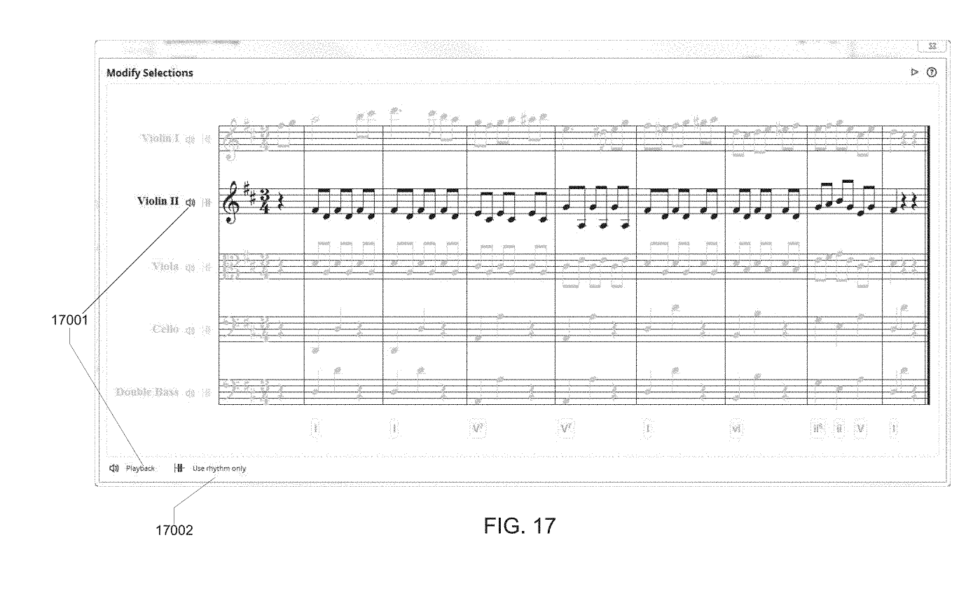

Referring now to FIG. 17, when a musical score (entire work or extract) is chosen within a question for playback, the instructor may non-destructively edit or manipulate the musical score and select which musical part(s) will be played back 17001. They may also toggle musical part(s) to percussion staff and convert the pitches to rhythmic values 17002; this is unused in FIG. 16, but 14001 shows this in use.

When notes or measures (bars) are selected to be hidden 12004, 12005, 13003, then different behaviours can result when the question is presented to the student. Areas of the score may be blank and have notes replaced with rests, and, the areas that are blank and have rests may be available for the student to edit 18001.

The claimed invention makes it possible to create questions with many variations. In this claim we have chosen to include four examples showing non-destructive editing in various ways.

The first example is a notation question and covers FIGS. 7, 12, 18 and 22. The area of musical study in this question example is melodic dictation.

Referring to FIG. 7, the notation question type is selected 703 and then notate as the specific type 704. The instructor has selected a musical score to present to the student 707. Once the musical score is chosen the instructor typically edits the score in a non-destructive manner, preparing it for student interaction. The instructor has also selected an audio example to be played 708.

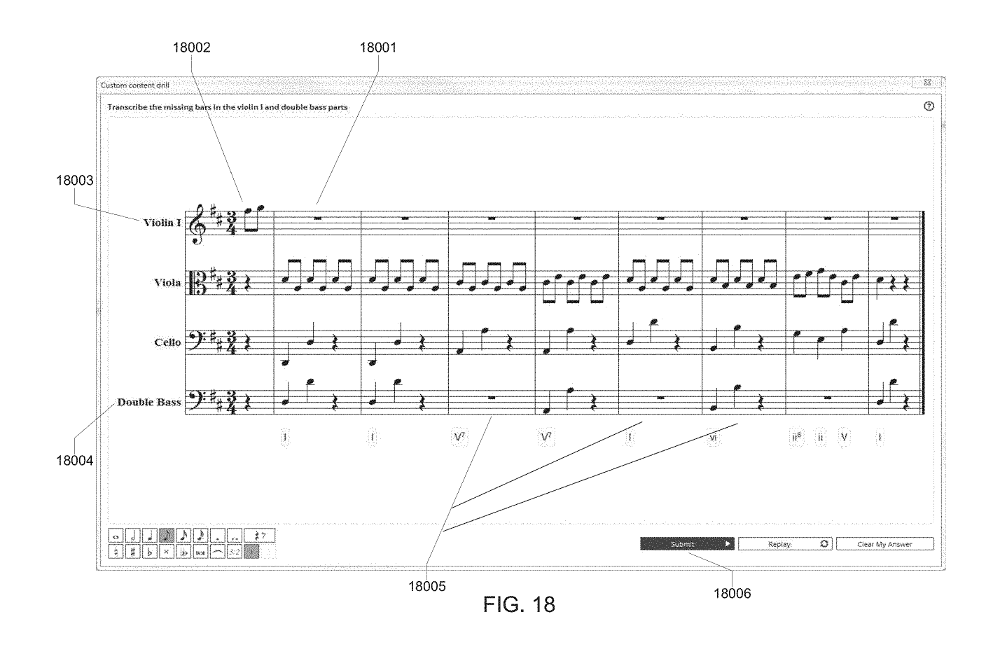

FIG. 12 shows the non-destructive editing of the score. In this instance, the Violin I part is both visible 12001 and editable 12002 and all notes will be hidden 12004 when presented to the student (FIG. 18) except those of the anacrusis 12006.

The Violin II part will not be shown to the student. The Viola, Cello and unlabelled chord symbol parts are visible but not editable.

The Double Bass part is both visible and editable and measures three, five and seven have the notes hidden 12005 when presented to the student (FIG. 18).

FIG. 18 shows the question or drill when it is presented to the student. As per the setup in FIG. 12, the only parts that a student may interact with are Violin I 18003 and Double Bass 18004. On those parts, only the areas 18001, 18005 can be edited, as per the selections in FIG. 12.

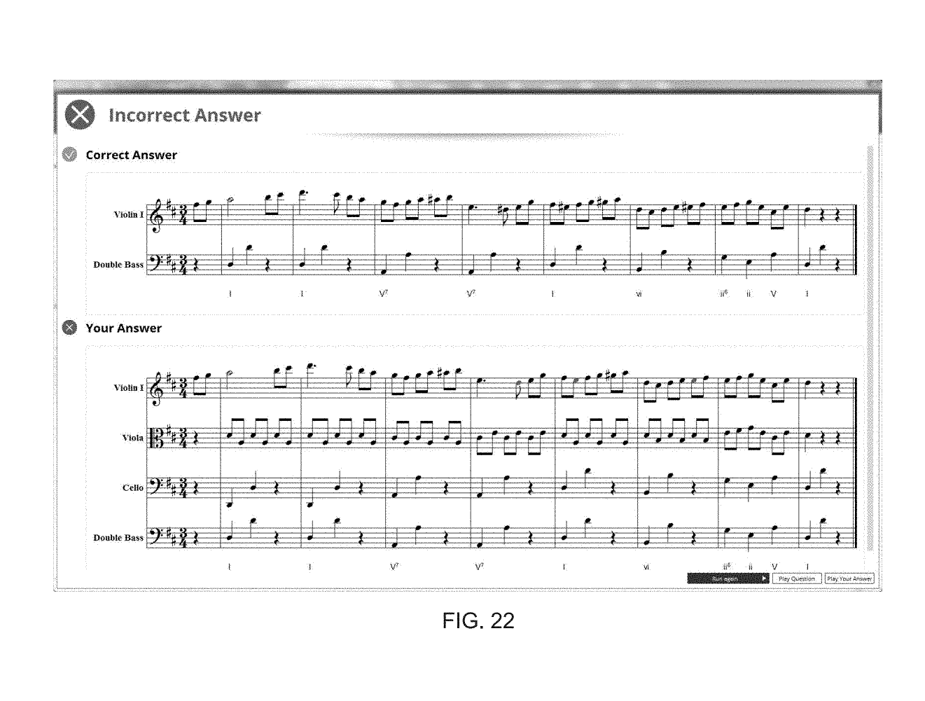

FIG. 22 shows feedback screen after the question in FIG. 7 has been automatically assessed by the integrated system after the student has inputted their answer.

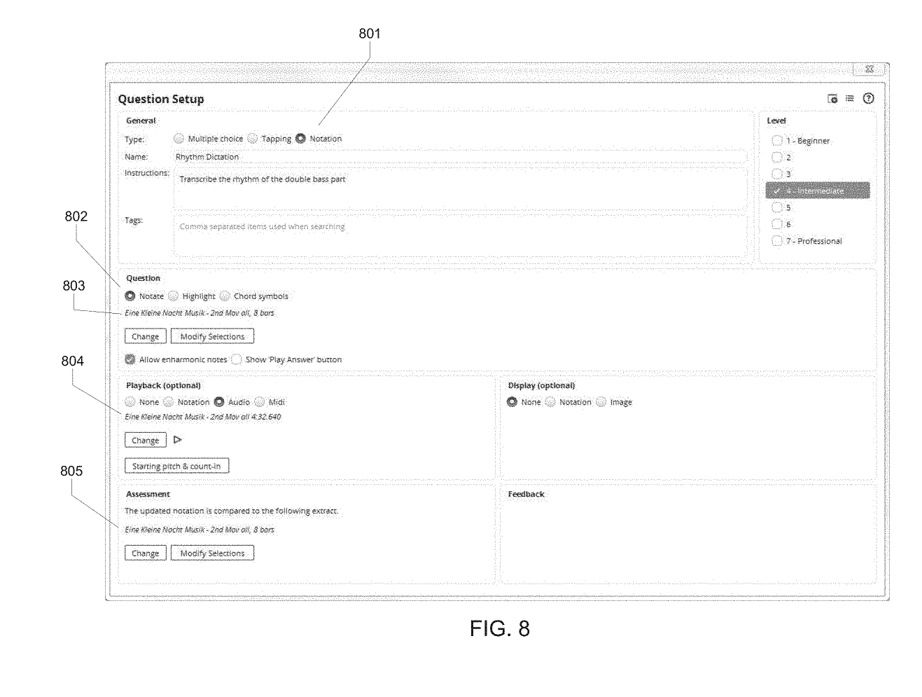

The second example is a notation question, and covers FIGS. 8, 13, 19 and 23. The area of musical study in this question example is rhythmic dictation.

Referring to FIG. 8, the notation question type is selected 801 and then notate as the specific type 802. The instructor has selected a musical score to present to the student 803. Once the musical score is chosen the instructor typically edits the score in a non-destructive manner, preparing it for student interaction. The instructor has also selected an audio example to be played 804.

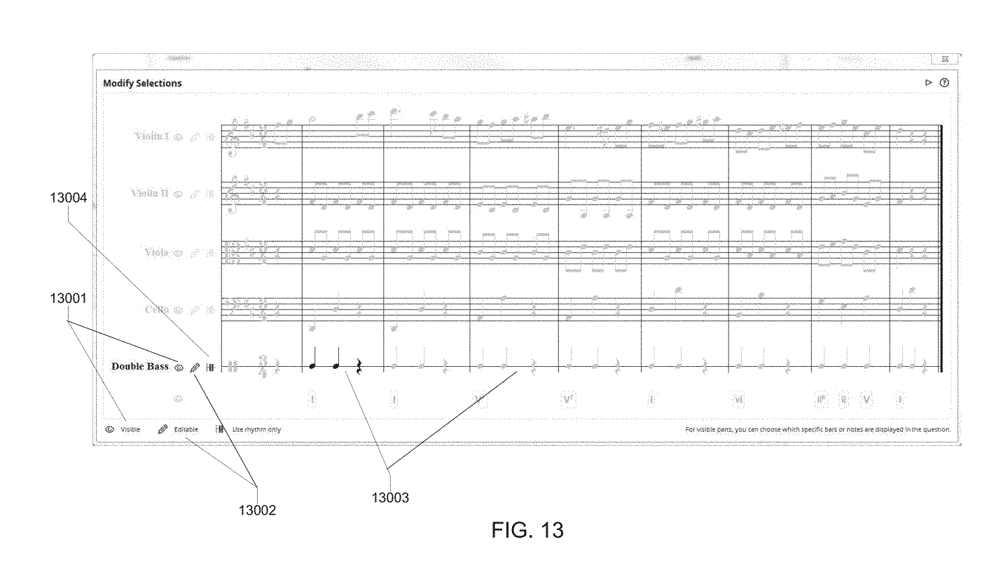

FIG. 13 shows the non-destructive editing of the score. The Violin I, Violin II, Viola, Cello and unlabelled chord symbol parts are all hidden.

The Double Bass part is both visible 13001 and editable 13002 and all notes will be hidden 13003 when presented to the student (FIG. 18) except those of the first measure 13003. The visible notes will have their pitches removed and staff changed to percussion 13004.

Note that this example is using the same musical score as in FIG. 7; reinforcing re-use of media items and their extracts. It is important to note that in this claim, each time a musical score item is used, non-destructive editing of the item can take place without altering other non-destructive edits.

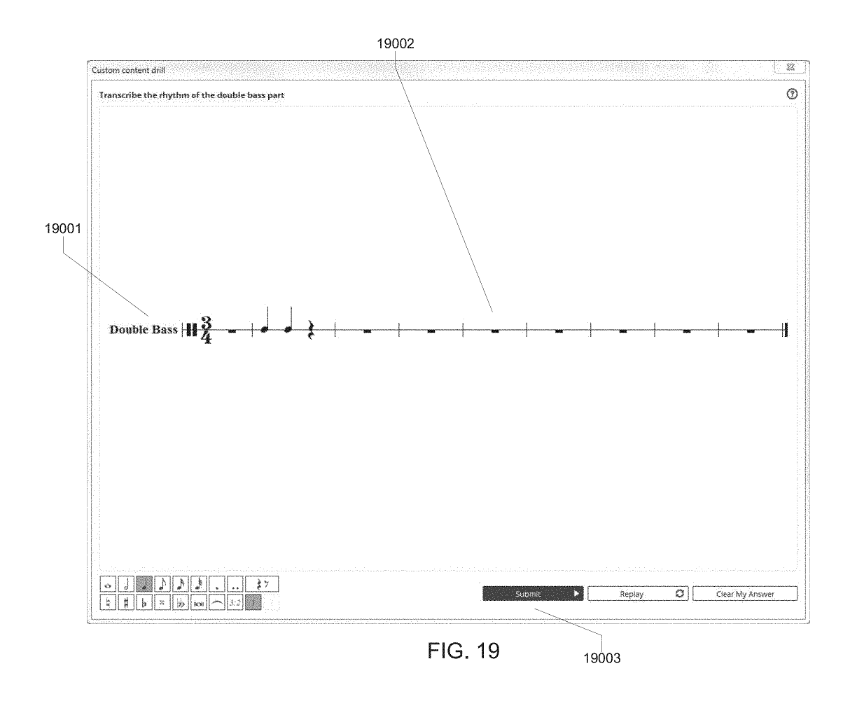

FIG. 19 shows the question or drill when it is presented to the student. As per the setup in FIG. 13, the only musical part that is visible is the Double Bass 19001 and only the area 19002 selected in 13003 can be edited.

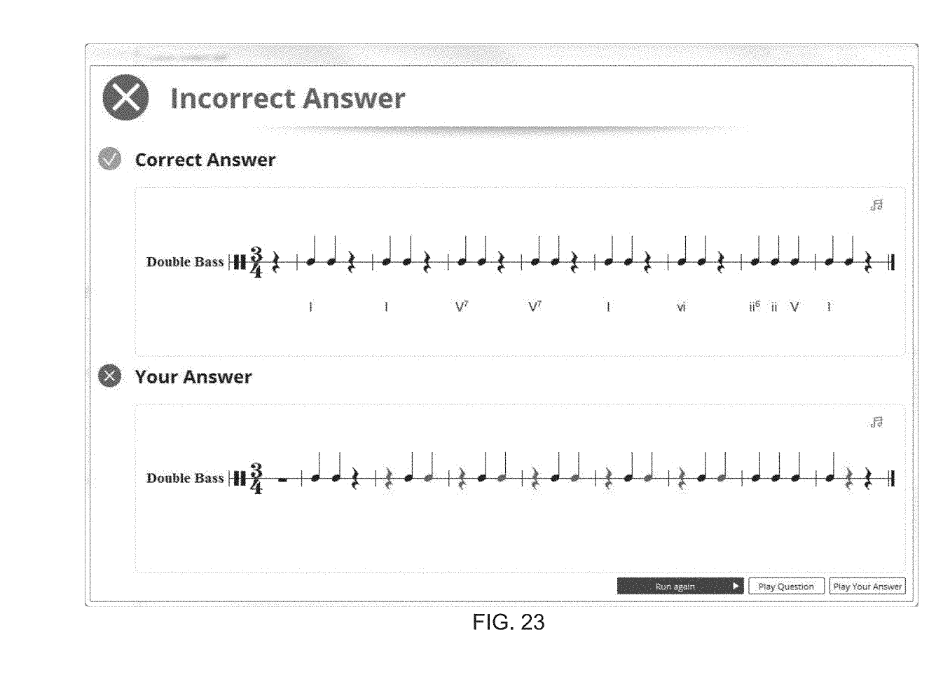

FIG. 23 shows the feedback screen after the question in FIG. 8 has been automatically assessed by the integrated system after the student has inputted their answer.

The third example is a tapping question, and covers FIGS. 9, 14, 20 and 24.

Referring to FIG. 9, the tapping question type is selected 901 and then ‘tap the displayed notation’ as the specific type 902. The instructor has selected a musical score to present to the student 905. Once the musical score is chosen the instructor typically edits the score in a non-destructive manner, preparing it for student interaction. This question has no playback 906 but a click track will automatically play when then music score is shown.

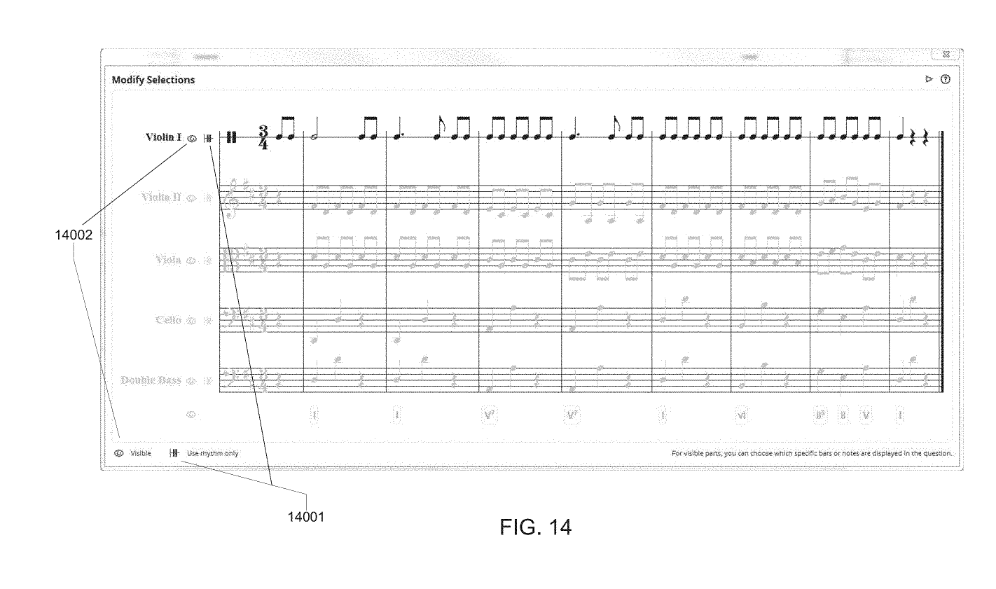

FIG. 14 shows the non-destructive editing of the score. The Violin II, Viola, Cello, Double Bass and unlabelled chord symbol parts are all hidden.

The Violin I part is both visible 14001 and has the pitches removed and staff changed to percussion 14001.

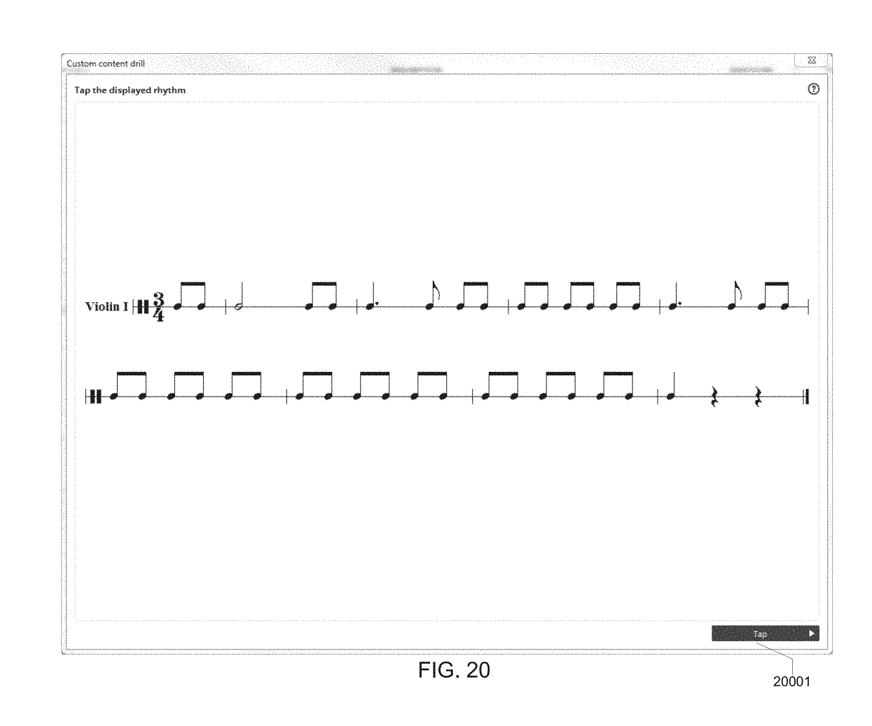

FIG. 20 shows the question or drill when it is presented to the student. As per the setup in FIG. 14, the only musical part that is visible to the student is the Violin I part, with the pitches removed and staff changed to percussion.

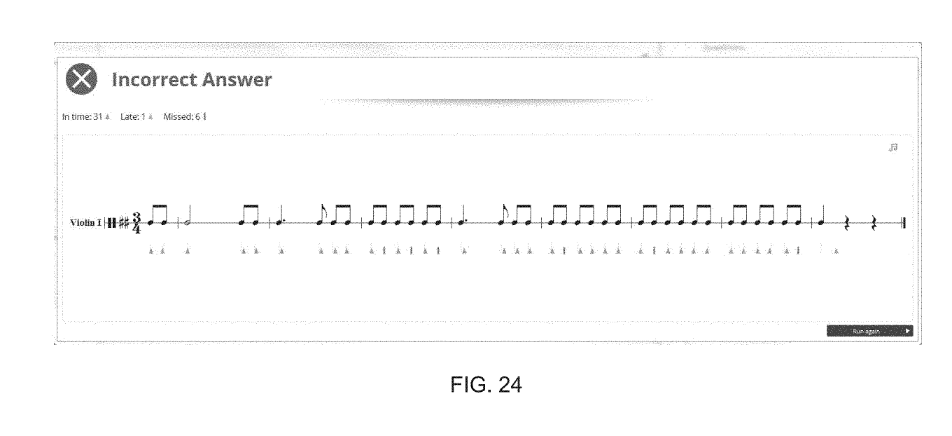

FIG. 24 shows the feedback screen after the question in FIG. 9 has been automatically assessed by the integrated system after the student has tapped their answer.

The fourth example is a multiple-choice question, with music scores or notation examples as answers, and covers FIGS. 10, 11, 15, 16, 17, 21 and 25.

Referring to FIG. 10, the multiple choice question type is selected 10001 and musical score or notation as the specific answer choice type 10004. The instructor must then select which musical scores or musical score extracts to present to the student as answer choices 10008.

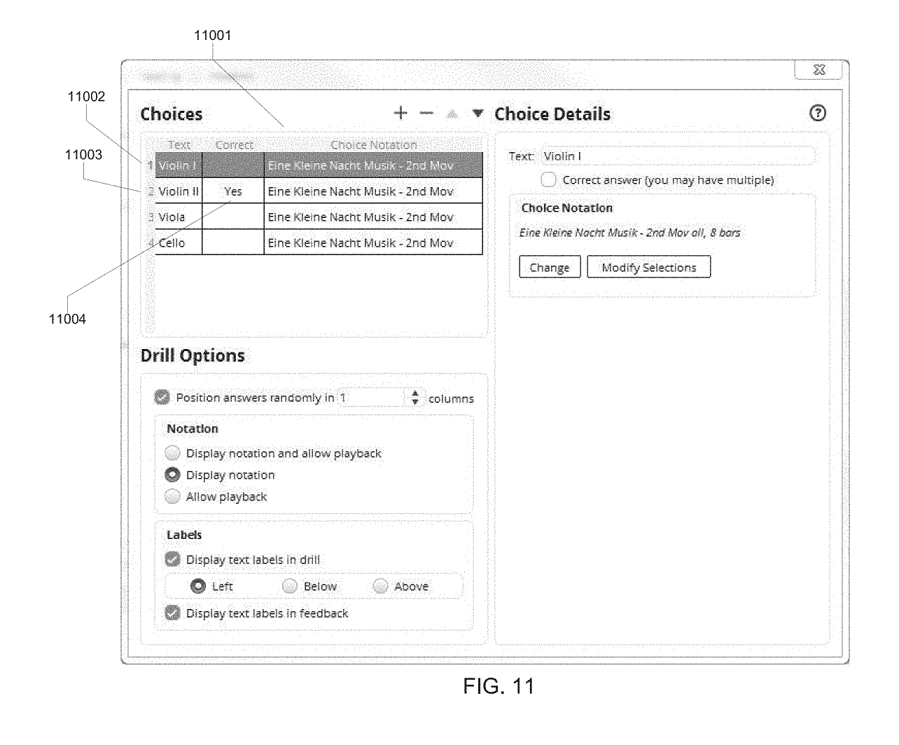

FIG. 11 shows screen where the choices are selected. In this example, four possible choices will be presented to the student 11001. Note that each of the four choices is using the same musical score or notation, with a different non-destructive edit for each choice, thereby making them unique for the student.

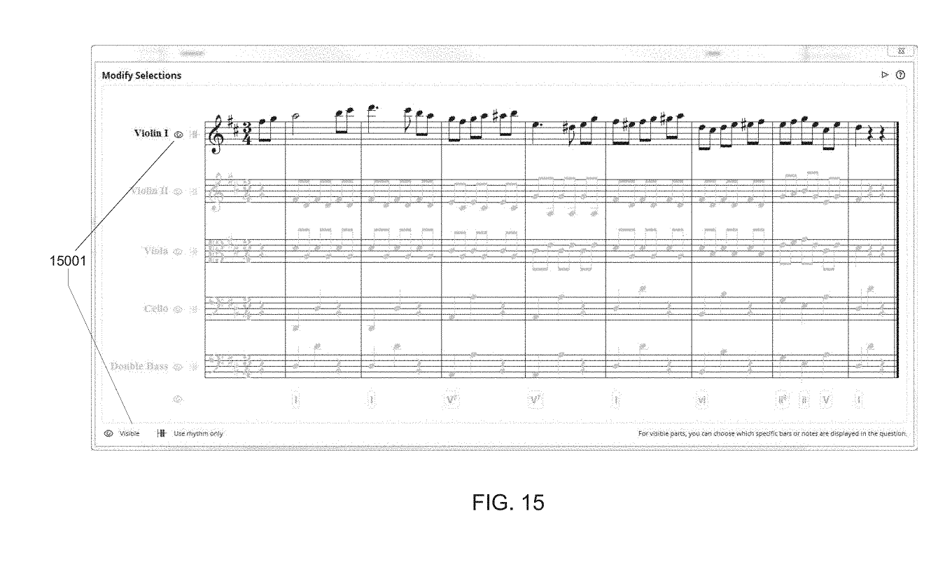

FIG. 15 shows the non-destructive editing of the first choice, named Violin II 1002. The Violin II, Viola, Cello, Double Bass and unlabelled chord symbol parts are all hidden, but the Violin I part is visible to the student 15001.

FIG. 16 shows the non-destructive editing of the second choice, named Violin II 11003. The Violin I, Viola, Cello, Double Bass and unlabelled chord symbol parts are all hidden, but the Violin II part is visible to the student 16001.

Referring again to FIG. 10, the instructor has also selected a musical score or notation to be played 10007. FIG. 17 shows the non-destructive editing of this item. The Violin I, Viola, Cello and Double Bass parts are not selected for playback, but the Violin II part is selected for playback 17001.

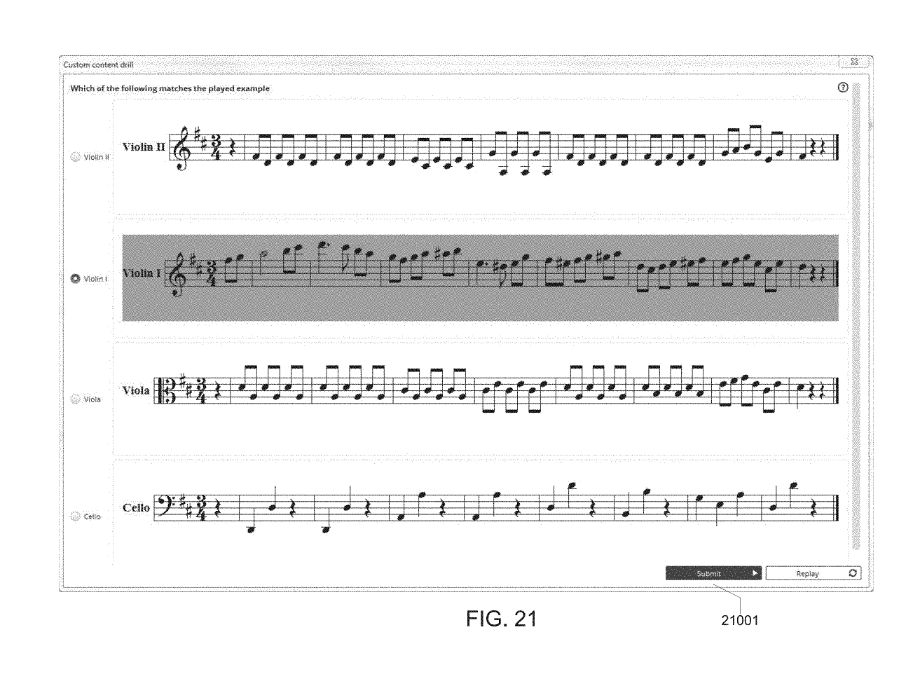

FIG. 21 shows the question or drill when it is presented to the student. As per the setup in FIG. 11, there are four musical score answers for the student to choose from.

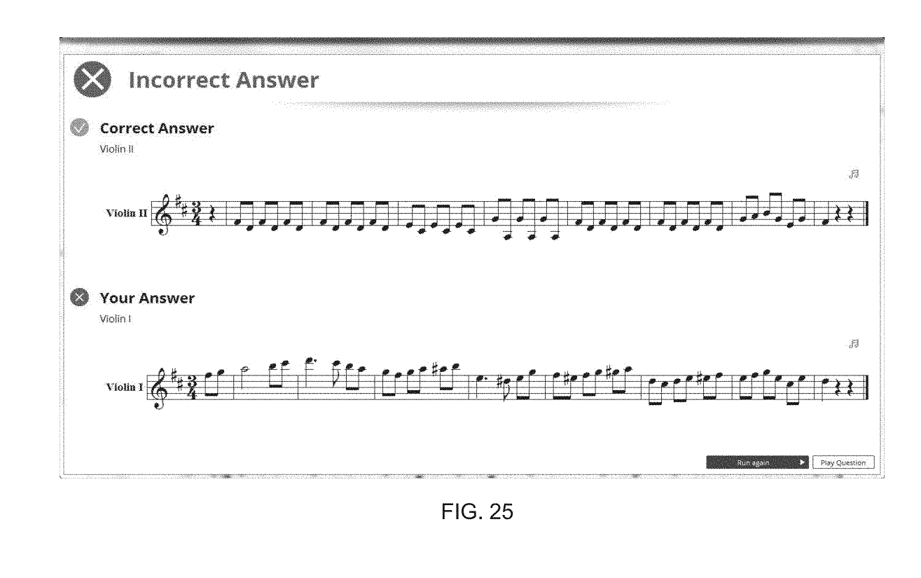

FIG. 25 shows the feedback screen after the question in FIG. 10 has been automatically assessed by the integrated system after the student has chosen their answer.

In one embodiment FIGS. 18, 19 and 21 show questions or drills when presented to the student. Collection of student results occurs once the student has answered the question and submitted their answer using the submit button 18006, 19003, 21001.

Referring to FIG. 20 which shows a tapping question or drill, the collection of student results occurs once the student has finished tapping 20001.

In each of the four examples student answers will be automatically assessed. The method of assessment differs depending on the question type.

A multiple-choice question is assessed automatically, the instructor will have nominated correct answer(s) in the question creation process 11004.

A notation question is assessed automatically by comparing the musical score originally manipulated by the instructor and presented to the student for interaction, with the musical score nominated for assessment by the instructor.

An instructor may manipulate the assessment musical score 805, modifying one or more selections of musical part(s) to be compared and toggling musical part(s) to percussion staff and converting pitches to rhythmic values.

A tapping question is assessed automatically by comparing against the manipulated display or playback musical score.

In each of the different embodiments shown in FIGS. 22, 23, 24, 25 feedback including results is provided on an interactive basis but this need not be so. It is not significant that any particular feedback including results, or communication, if any, is done interactively or using any particular form.

1. An integrated system comprising:
one or more digital devices containing:
code that enables the non-destructive editing a of musical score by an instructor, wherein the instructor is provided on more or more of the digital devices with non-destructive editing options that include one or more of the following;
selection of one or more musical part(s) that are made visible,
selection of one or more musical part(s) that are made heard,
selection of one or more musical part(s) that are made editable for a student,
hiding one or more notes of said selection(s),
hiding one or more measures of notes of said selection(s), and
toggling of one or more musical part(s) to percussion staff and converting pitches to rhythmic values;
code that enables the creation of a question by the instructor based on the non-destructive editing;
code that enables the presentation of said question to student(s);
code that enables collection of the said student(s) answer(s); and
code that enables assessment of the said student(s) answer(s).

2. (canceled)

3. The integrated system of claim 1, wherein said musical score is provided by the publisher of said integrated system, a third-party provider, or provided by or created by said instructor.

4. The integrated system of claim 1, wherein further the said creation of questions are one of multiple choice notation, or tapping.

5. The integrated system of claim 4, wherein the said creation of a multiple choice question comprises one of text, image, musical score, audio, or a MIDI file.

6. The integrated system of claim 4, wherein said creation of a notation question comprises one of entering one or more notes on a musical score, entering one or more chord symbols on a musical score, or highlighting one or more elements on a musical score.

7. The integrated system of claim 4, wherein said creation of a tapping question comprises one of tap a displayed musical score to a click track, tap along with a played musical score, remember and tap a played musical score.

8. The said integrated system of claim 1, wherein the non-destructive editing of a musical score allows creation of an extract comprising selection of starting and finishing measures and beats from a musical score.

9. The integrated system of claim 8, wherein said extract is re-used in multiple questions.

10. (canceled)

11. The integrated system of claim 1, further comprising code that enables said assessment being communicated to said student.

12. A computerized method for non-destructive music editing, question creation, and assessment using digital devices, comprising the steps of:
the non-destructive editing of music by an instructor whereby the instructor is provided on one or more of the digital devices with non-destructive editing options that include one or more of the following functional options:
selection of one or more musical part(s) that are made visible,
selection of one or more musical part(s) that are made heard,
selection of one or more musical part(s) that are made editable for a student,
hiding one or more notes of said selection(s),
hiding one or more measures of notes of said selection(s),
toggling of one or more musical part(s) to percussion staff and converting pitches to rhythmic values,
creation of a question by the instructor based on the non-destructive editing;
presentation of said question to student(s),
collection of the said student(s) answer(s), and
assessment of the said student(s) answer(s).

13. (canceled)

14. The method of claim 12, wherein, said musical score is provided by the publisher of said computerized method, a third-party provider, or provided by or created by said instructor.

15. The method of claim 12, wherein said creation of questions are one of multiple choice, notation, or tapping.

16. The method of claim 15, wherein said creation of a multiple-choice question comprises one of text, image, musical score, audio, or MIDI file.

17. The method of claim 15, wherein said creation of a notation question comprises one of entering one or more notes on a musical score, entering one or more chord symbols on a musical score, or highlighting one or more elements on a musical score.

18. The method of claim 15, wherein said creation of a tapping question comprises one of tap a displayed musical score to a click track, tap along with a played musical score, or remember and tap a played musical score.

19. The method of claim 12, wherein the non-destructive editing of a musical score allows creation of an extract comprising or selection of starting and finishing measures and beats from a musical score.

20. The method of claim 19, wherein said extract is re-used in multiple questions.

21. (canceled)

22. The method of any of claim 12, further comprising the step of said assessment being communicated to said student.
